(19) United States
(12) Patent Application Publication
(10) Pub. No.: US 2010/0019019 A1
(43) Pub. Date: Jan. 28, 2010

(54) Album Digital Post-card

(75) Inventor: Claude MAIDEMBERG, Plozevet (FR)

Correspondence Address: MAIDEMBERG Claude, Prat Meur, Plozevet, 29710, FR

(73) Assignee: Claude Maidemberg, Plozevet (FR)

(21) Appl. No.: 12/177,154

(22) Filed: Jul. 22, 2008

(51) Int. Cl. B42D 15/02; B65D 27/04

(52) U.S. Cl. 229/92.8; 229/71

(57) ABSTRACT

The present invention concerns a device that acts as a medium for multimedia communication, the collection, arrangement and display of this medium, exploiting a combination of the advantages of traditional means of communication (letter, post-card, personal announcement, etc.) and the use of souvenir albums, means for storing CDs/DVDs/Blu-Ray DVDs (storage furniture, folders, etc.), means of display (photo frame, poster, magnet, etc,) as well as the advantages of digital convergence in communication, in multimedia and in interactivity such as the textual and multimedia communication of personal and professional messages thanks to Internet services and the exploitation of the multimedia content of CDs, DVDs and the Blu-Ray DVD with its personalisable functions of interactivity and of connectivity to the Internet thanks to a DVD player. It comprises a material medium (SM) with two self-adhesive strips (SM2-H/J) or a magnetic surface (SM2-MAN) and a digital medium (SN) and a fixing device (DFR) bringing them together. It is also equipped with these connecting devices (CA), (XR), (VR) enabling the user to group the CPNAs together to make a souvenir album or to make a poster and/or a display or a means for storing CDs/DVDs/Blu-Ray DVDs. The material medium (SM) and the digital medium (SN) are brought together by a reusable and repositionable fixing device (DFR), inserted in an envelope (EV) so as to be protected while the CPNA is dispatched through the postal system and preserved after the CPNA has been received. For the purposes of distribution and/or retail, these elements are displayed to view in a translucent pouch (ST). While benefiting from traditional modes of transmission (postal dispatch or specific dispatch or personal delivery) the CPNA conveys a large volume of multimedia interactive content that is beyond the reach of current electronic transmission networks. The invention also dispenses with external media and add-ons by doubling up as a souvenir album and/or a means for storing CDs and DVDs and/or by displaying itself as a poster. Providing a fully interactive, personalisable and connected environment, the CPNA places a complete digital communication tool within the reach of private individuals, professionals, institutions and their correspondents, all within the compact dimensions of a post-card.

### INDICATION OF THE TECHNICAL DOMAIN OF THE INVENTION

The present invention concerns a device that acts as a medium for multimedia communication, the collection, arrangement and display of this medium, exploiting a combination of the advantages of traditional means of communication (letter, post-card, personal announcement, etc.) and the use of souvenir albums, the methods of storing the CDs/DVDs/Blu-Ray DVDs (storage furniture, folders, etc.), means of display (photo frame, poster, magnet, etc,) as well as the advantages of digital convergence in communication, in multimedia and in interactivity such as the textual and multimedia communication of personal and professional messages thanks to Internet services and the exploitation of the multimedia content of CDs, DVDs and the Blu-Ray DVD with its personalisable functions of interactivity and of connectivity to the Internet thanks to a DVD player.

This device, while acting as a digital communication medium, dispenses with the medium of electronic transmission networks by using the postal system as a means of transport as well as letters and post-cards. It also dispenses with external media and add-ons by doubling up as a souvenir album and/or a means for storing CDs and DVDs and/or by displaying itself as a poster.

The invention enables digital convergence techniques such as interactivity, connectivity to the Internet and the means of personalisation and of traditional transfer and archiving media to complement each other in the context of communication between individuals and collectors as well as between companies and institutions and their correspondents.

The CPNA provides a global solution for communication and traditional archiving (non-electronic) to the sender of an illustrative and personalisable content that is richer, more complex and considerably more voluminous for an electronic network such as the Internet and numerous advantages to the recipient of this message, as a souvenir album or as a display device.

Indication of the Previous State of the Technology which gave Rise to the Technical Problem Posed

Ever since the introduction of postal services, it has been possible to communicate by mail in order to convey a document on a paper medium inserted in an envelope and stamped with the appropriate value and sent by post. The advent of the post-card, dating from 1869, has enhanced this form of communication through the addition of pictures.

For the past few decades, electronic communication (telephone, the Internet, cellular telephone) has been increasingly enhanced by digital multimedia materials (digital text, pictures, sound, animation, digital pictures). These same forms of digital content can be stored on bulk memory media (hard disc, replaceable disc, CD, DVD, memory-cards, electronic chips, etc.) and form the core resources of this communication itself.

On one hand, the traditional means of communication (mail, post-card) cannot contain the wealth of communication that is widespread and available to every individual today. The medium of paper alone is incapable of conveying the richness of digital multimedia communication (pictures, sound, high-definition images, animation).

On the other hand, today's electronic communication networks are not yet able to disseminate a meaningful of multimedia content (compared with a CD or a DVD) and so limit themselves to transmitting content in small volumes (email, voice messages, SMS, MMS).

### Exposition of the Invention

The CPNA device that has been invented of the type CPN (Patent No. FR2889823), which links the traditional means of sending messages by mail with the richness of digital multimedia channels is also characterized by the main claim offering the possibilities of creating a collection of devices (CPNAs) and of interacting in a personalisable manner with the Internet from a Blu-Ray DVD player in addition to the traditional means such as personal computers.

According to the following claims (2, 3, 4 and 5), the device described by the present invention offers the possibility of creating a self-adhesive or magnetic poster and/or wall poster. According to the same claims, the present invention also offers the possibility of creating a storage device for these devices.

The content of the digital medium is created partially (or entirely) by the commercial user and incorporates the benefit of all the technologies and techniques of multimedia communication: text and/or sound and/or image and/or video and/or photographic montage and/or 3D and/or computer-generated image and/or a multimedia application and/or personalisable applications that can interact with the Internet, etc. The texts and soundtrack are structured in a multilingual version.

In the context of the description of the invention the term CPNA denotes the name of the invention: the Album Digital Post-card. The invention comprises 5 distinct elements that make up this device:

SM, The material medium: (1&2)

This is normally a card medium sufficiently rigid yet supple enough to meet the requirements of mail sorting where necessary. This medium consists of an front side (SM1) and a back side (SM2). The front side (SM1) contains an image or a printed message created by the commercial user. The front side (SM1) also supports a reusable and repositionable fixing device (DFR). The back side (SM2) contains a printed message designed by the commercial user (this may be the commercial user's name and other useful information) and/or a handwritten message from the sender. On the back side of the material medium (SM2) there are one or two self-adhesive reusable or “permanent” surfaces (SM2-H-J) with their protective film (SM2-H-1 & SM2-J-1) acting to secure the CPNAs to each other and a fluting field (SM2-1) on the side corresponding to (SM2-H) to facilitate the articulation of the “CPNA” album thus constituted. This “CPNA” is used for the archiving and/or storage and/or collection of CDs/DVDs/Blu-Ray DVDs (CPNA-S-CA & CPNA-A-CA).

The SM medium has an additional add-on, the album wedge (CA) and its self-adhesive strip (CAC) and its protective film (CAC_1) to overcome the problem of the asymmetry of the form of the album obtained as a result of the securing together of a relative large number of CPNAs and because of the accumulated height of the fixing device of the DVDs (DFR) by superimposing the CPNAs the one on top of the other.

The self-adhesive strips (SM2-H-J) are made from an industrially adhesive material applicable and can be applied to and peeled off from the surface SM1 and/or the wall and/or any smooth surface a relatively large number of times. The “permanent” variant is coated with an adhesive substance to secure it very firmly to the surface to which it is applied.

The protective films (SM2-H-1 & SM2-J-1) are protective covers for the self-adhesive strips (SM2-H-J) which prevent the accidental adhesion of the self-adhesive strips and protect them during transportation.

The album wedge (CA) is made from a light plastic material or dry foam or the equivalent, the length of which is equal to the side SM2-H and the width of which does not extend beyond the part of the CPNA located between the side SM2-H and the fluting field SM2-I.

The self-adhesive strip (CAC) is made in the same way as the (SM2-H-J) and their. “permanent” variant.

The protective film (CAC_1) is made in the same way as the (SM2-H-1 & SM2-J-1).

The material medium SM may be pre-punched with 4 holes (SM2-K1-2-3-4), which, once hollowed out, possess a certain degree of elasticity to support the introduction of the connecting devices (AR, XR and VR) for a relatively long time.

The three additional connecting add-ons of the medium MM are described as follows:

the connecting ring connecting device (AR) with its opening (ARO) for passing the CPNA through the ring, the bi-card connecting device (VR) with its two connecting pins (XVE) with a neck (XVEC) and a head (XVET) for linking two CPNAs, the quadri-card connecting device (XR) with the four connecting pins described above for connecting four CPNAs. These three devices enable the commercial user to display or show a set of cards by all methods and at will, to make a poster, a display or a means of storing the CDs/DVDs/Blu-Ray DVDs.

The material medium MM may be used as a poster being secured by the self-adhesive strips (MM2-H-J) to a wall medium or to any surface. With three additional connecting add-ons (AR, XR and VR) the material media MM may be connected to each other in order to be secured (to a wall medium or to any surface) as a poster (CPNA-A) and/or displayed (suspended or hung from hooks) by different means (CPNA-M) and/or as a curtain or a suspended sign, presented here as non-restrictive examples.

The material medium SM may be used in the two preceding cases as a wall storage device for CDs/DVDs/Blu-Ray DVDs or as an independent storage device for placing on a desk or on any piece of furniture (CPNA-R).

SM2_M, The magnetic variant of the material medium: (31&32)

The material medium SM has a variant with a magnetic back side “SM2-MAN”. According to this variant, the “Magnetic Poster CPNA” (CPNA-AM), the back side (SM2-MAN) no longer contains the sub-characteristics of (SM2) cited above (SM2-D-E-F-G-H-I-J-K) but a magnetic surface (SM2-MAN) (31) enabling it to attach itself by magnetic force to any metal surface allowing this. This variant is accompanied by a non-obligatory label (SM2-ETQ) (32) with certain sub-characteristics of SM2 (MM2-D-E-F-G) to enable the sender to affix a stamp, to write the address of the addressee accompanied by a personal and/or pre-printed message as well as the legally required information and the information of the commercial user FIG. 10.

SN, The digital medium: (3 & 4)

The digital medium is a CD (12 cm) or a Mini-CD (8 cm) a DVD (12 cm) or a Mini-DVD (8 cm) or a Blu-Ray DVD (12 cm) or a Blu-Ray Mini-DVD (8 cm). The content of these media is designed by the commercial user apart from the personalisable part. These media are readable on any VCD and/or DVD and or Blu-Ray DVD player and/or on PC compatible computers and/or on Macintosh computers and/or on games consoles and/or on video cameras equipped with a VCD player and/or DVD player and or Blu-Ray DVD player capable of establishing an Internet connection.

This digital medium contains a multimedia production comprising text, sound and/or still and/or animated images and/or links to Internet sites as well as an interactive system enabling the user to intervene in the viewing as well as features of interaction and personalisation and connectivity specific to Blu-Ray DVD.

In cases where a Blu-Ray DVD is used, the commercial user may interact on the Internet directly from his or her DVD player connected to the Internet and benefits from the personal and/or authorised content personalisation functions of his or her Blu-Ray DVD.

EV, The envelope: (5&6)

This paper envelope is the default medium for dispatch by mail and is made from a material sufficiently rigid to withstand mechanical constraints of transport and supple enough to guarantee successful mail-sorting. This same envelope can provide protection if the CPNA is retained instead of being mailed, or after mailing.

DFR, The reusable and repositionable fixing device: (7)

The digital medium must be firmly fixed to the material medium (SM1) and must provide a fastening for the digital medium (3&4) while allowing it to be removed from its fastening and, if necessary, replaced on its fastening, and to be inserted in the envelope (5&6).

ST, The translucent pouch: (9)

The translucent pouch contains all the other elements for the purpose of distribution or of making the invention available to the public.

Given the particular embodiments of the invention of type CPN (Patent No. FR2889823) we proceed differently according to these particular embodiments:

The (CPNA Album) being the master layout of the CPNA the elements of which were brought together and self-cohered thanks to the self-adhesive strips SM2-H or SM2-J with or without the album wedges (CA).

The (CPNA Storage), being another layout of the CPNA, constitutes a storage object for DVDs.

La (CPNA Poster), which is another variant of the (CPNA Storage) the elements of which are arranged in such way as to be displayed by all means and/or on a surface and/or on a wall.

### PRESENTATION OF THE DIFFERENT FIGURES MAKING UP THE DESIGNS

FIG. 1 represents the front side and the back side of the material medium (SM), the front side of the digital medium (SN), the reusable and repositionable fixing device (DFR), the self-adhesive strips (SM2-H & SM2-J), the prepunched connecting holes (SM2-K1-2-3-4) and the details of their respective sub-fields where necessary.

FIG. 2 represents the front side and the back side of the digital medium (SN).

FIG. 3 represents the front side and the back side of the envelope (EV) and the details of their respective sub-fields.

FIG. 4 represents:

on the left-hand side the reusable and repositionable fixing device (DFR) and its sub-field and on the right the translucent pouch (ST) and the details of its self-adhesive arrangement (10).

FIG. 5:

It represents the album wedge (CA) for the variant “CPNA Album” and the 3 connecting devices for the two variants “CPNA Storage” and “CPNA Poster” (AR, VR, XR). It represents the details of the connecting ring opening (ARO). It represents the details of the connecting pin (XVE) of the quadri-card connecting devices (XR) and duo-card connecting devices (VR), the neck of the pin (XVEC) and its head (XVET). It also represents the details of the self-adhesive strip (CAC) of the album wedge (CA) and its protective film (CAC_1).

FIG. 6:

It represents the CPNA Album with a wedge (CPNA-A-CA) or without a wedge (CPNA-S-CA).

FIG. 7:

It represents the CPNA Storage (CPNA-R) with the linking rings (AR).

FIG. 8:

It represents the CPNA Poster (CPNA-A) with the connecting devices (XR, XV).

FIG. 9:

It represents a hybrid CPNA version with the connecting devices (AR) for hanging and the connecting devices (XR, XV) for consolidation.

FIG. 10:

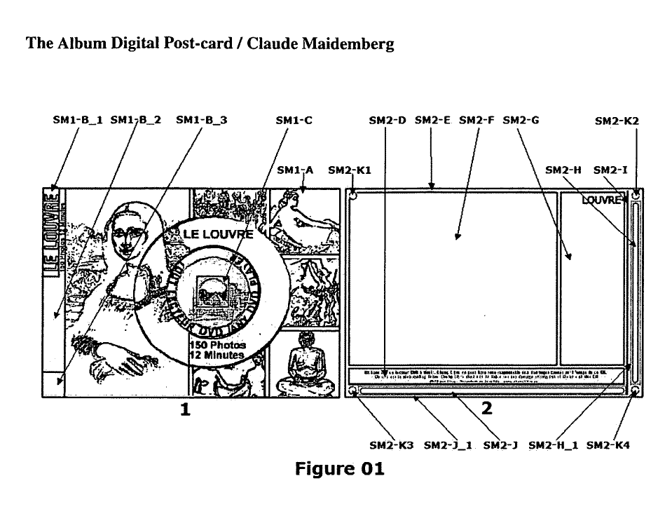

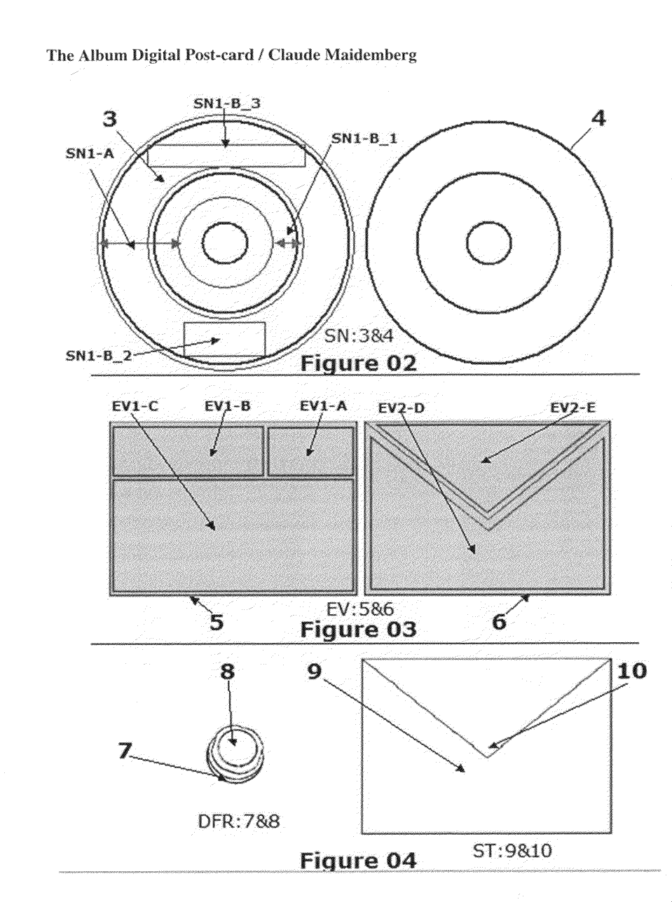

It represents an CPNA-AM version with the magnetic surface SM2-MAN (31) and the accompanying label SM2-ETQ (32). On the label we can see the sub-characteristics SM2-D-E-F-G to enable the sender to send it as a post-card.

### DETAILED EXPOSITION OF THE METHOD OF PRODUCING THE INVENTION

With reference to these drawings, the production of the Album Digital Post-card necessitates the production of 5 distinct elements and their four add-ons regarding the creation of the CPNA device and the assembly of the device.

Given a digital post-card of the type CPN (Patent No. FR2889823), the CPNA has the following embodiments:

SM, The material medium: (1&2)

This is the normal material medium (SM) necessary to the invention. It is structured like a traditional post-card produced industrially by printing and/or varnishing a card medium. Its chief characteristics are a front side SM1 and a back side SM2 described as follows.

On the front side (SM1), it comprises a printed selection of images contained in the digital medium (3&4) and information about the product and/or the content of the product designed by the commercial user. On the back side (SM2), according to the main characteristic, it comprises two reusable or permanent self-adhesive strips for adhesion and, according the 4 remaining characteristics, it has four pre-punched holes and the connecting add-ons. On the front side (SM1) and the back side (SM2) the commercial user can print legally required or other information, a message, an image or a group of images, or any type of graphic presentation, at the same time leaving a space in which the sender can compose a personal message.

Here are the details of its production:

SM Material Medium as the invention's default medium characterised by the elements described as follows:

SM1—On the front side of the material medium:

Are printed a group of described elements, the number, arrangement and dimensions of which are given here only as non-restrictive examples:

SM1-A

The Photo Field: Normally situated on the left and containing the photo(s) and/or graphic element(s) taken from the digital medium.

SM1-B

The Commercial User Field: Normally situated on the right and containing 3 sub-fields:
SM1-B_1
Sub-field for personalised information and messages
SM1-B_2
Sub-field containing the number of images and duration of the content
SM1-B_3
Sub-field for the logo of the commercial user

SM1-C

The field for the reusable and repositionable fixing device for the self-adhesive surface (7) of the reusable and repositionable fixing device DFR enabling the part (8) to hold the digital medium in place.

SM2: On the back side of the material medium:

Are printed a group of elements, the number, arrangement and dimensions of which are given here only as non-restrictive examples:

SM2-D

The field for the legally required information: Normally situated at the bottom of the back side of the material medium (SM2) containing the artists' and/or manufacturers' credits and/or copyrights and/or the description of the area of responsibility of the commercial user and/or the legally required information of the commercial user.

SM2-E

The background image field: Normally covering the entire back side of the material medium (MM2) in a semi-translucent manner.

SM2-F

The field of the message of the sender: Normally situated on the left and normally containing the sender's typewritten, handwritten or printed message.

SM2-G

The field for information from the commercial user: Normally situated on the right and containing the title or heading chosen by the commercial user and/or descriptive information from the commercial user and/or the content descriptions of the digital medium (SN2 & SN1).

SM2-H

The reusable (or permanent) self-adhesive strip: According to the main characteristic it is normally situated on the right of SM2 over the entire height of the material medium excluding the zones reserved for the pre-punched holes SM2-K1-2-3-4 (described below), to secure the CPNAs together, comprising an album, and/or to secure them to a wall or to any other surface. The protective film (SM2-H_1) is a protective cover that prevents the accidental adhesion of the self-adhesive strip and protects it during transportation.

SM2-I

The fluting field on the material medium (SM2): According to the main characteristic it is normally situated on the right of SM2 over almost the entire height of the material medium enabling folding appropriate for the articulation of the CPNAs mounted in an album.

SM2-J

The reusable (or permanent) self-adhesive strip: According to the main characteristic it is normally situated at the bottom over the entire length of the material medium excluding the fluting field SM2-I and the zones reserved for the pre-punched holes SM2-K1-2-3-4 (described below), to secure the CPNAs together and/or to secure them to a wall or to a pane of glass or to any other surface. The protective film (SM2-J_1) is a protective cover that prevents the accidental adhesion of the self-adhesive strip and protects it during transportation.

SM2-K1-2-3-4

According to claim 3, the four pre-punched holes of the CPNA act to attach the cards to each other for the purpose of archiving, displaying, viewing or storing. The connecting add-ons are explained in section (AR, VR et XR).

SM2-MAN

According to claim 4, the variant “CPNA Magnetic Poster” (CPNA-AM) has a magnetic back side (SM2-MAN) (31) and is accompanied by a non-obligatory label (SM2-ETQ) (32) with the sub-characteristics (SM2-D-E-F-G).

SN, The digital medium: (3&4)

This is the normal digital medium of the invention, characterized by a CD or a DVD or a Blu-Ray DVD or a Mini-CD or a Mini-DVD or a Blu-Ray Mini-DVD, the content of which is designed and produced essentially by the commercial user on the basis of photographic documents montage and/or films and/or sound recordings and/or any documents capable of being made use of in a multimedia production and/or links to an Internet site and/or HTML pages. It is a digital medium of type CPN (Patent No. FR2889823) characterised by the following special features:

The picture fields, the sound fields, the text fields, the animation functions, the interactivity functions and the applications supplemented by: the interaction and personalisation applications connected to the Internet benefiting from any Intranet, Extranet and Internet technologies (SN2-B). This characteristic is based on the exclusive possibilities of personalisable interaction and the connectivity of the Blu-Ray DVD in the television and computing environment. This may serve as a non-restrictive example of an artistic and/or scientific and/or literary and/or leisure and/or sports and/or cultural and/or professional production.

The front side of the digital medium SN 1 normally has a printed or silk-screened design highlighting the aesthetic aspects of the commercial user of the CPN, at the same time increasing the area reserved for the graphic display on the front side of the material medium (SM2) upon which it is placed thanks to the reusable and repositionable fixing device (5). In a digital variant, the front side of the digital medium SN1 can serve for the embossing or engraving of the digital elements of a reproduction. All the elements are described as follows:

SN1—On the front side of the digital medium: (3)

Are printed or silk-screened a group of described elements, the number, arrangement and dimensions of which are given here only as a non-restrictive example:

SN1-A

The Photo Field: Normally situated on the whole printable surface and containing the photo(s) and/or the graphic elements taken from the digital medium.

SN1-B

The Commercial User Field: Normally occupying sub-fields of the printable surface and containing 3 sub-fields:
SN1-B_1
Sub-field for personalised information and messages
SN1-B_2
Sub-field containing the number of images and duration of the content
SN1-B_3
Sub-field for the logo of the commercial user

SN1—Digital variant (3)

On this are impressed or engraved (on the same front side itself, making the SN into a double-sided medium) the elements of a reproduction, the content of which is given here only as a non-restrictive example:
SN1—Digital variant_1
Audio tracks structured as an audio CD or an audio DVD or an audio Blu-Ray DVD
SN1—Digital variant_2
Video-audio Clips structured as a VCD or a SVCD or a DVD or a Blu-Ray DVD
SN1—Digital variant_3
A film structured as a VCD or a SVCD or a DVD or a DVD Blu-Ray
SN1—Digital variant_4
Artistic performances structured as DM2.

SN2: The back side of the digital medium: (4)

Is reserved for the pressing or engraving of a reproduction of content and/or the personalisation of private and/or authorized content available on the medium SN2 according to the characteristics set out above.

This digital medium contains a multimedia production comprising text and/or sound and/or still and/or animated images and/or links to Internet sites as well as an interactive system enabling the user to intervene in the viewing.

In cases where a Blu-Ray DVD is used, the commercial user may interact on the Internet directly from his or her DVD player connected to the Internet.

SN2-A: The multimedia and interactive functions of the type CPN (Patent No. FR2889823).

SN2-B: The functions of interaction, personalisation and connectivity specific to the Blu-Ray DVD.

DFR, The reusable and repositionable fixing device: (7&8)

This is a self-adhesive fixing device (7). It is fixed on the front side of the material medium (SM1) on the sub-field MM1-C thanks to a self-adhesive surface, making it possible to keep the digital medium (3&4) in place. This is achieved by the flexible securing element of a central core (8) and by means of the screwing of the medium SN onto the part (8) of the DFR. The digital medium SN is detached from its attachment (8) by being unscrewed or pulled away (according to the different type of DFR used) and by being pulled away from the part (8) of the DFR.

EV, The envelope: (5&6)

This is designed like a postal envelope with dimensions suitable for enclosing the material medium (1&2). This envelope can be made from any material suitable for protecting the material medium (1&2) and for handling in the mail. It can have the benefit of overprinting in order to reinforce the message of the commercial user.

Here are the production details:

EV1—On the front side of the envelope: (5)

Are printed a group of described elements, the number, arrangement and dimensions of which are given here only as a non-restrictive example:

EV1-A

The postage field: Normally located at the top on the right and reserved for postage stamps and marks.

EV1-B

The field for information from the commercial user: Normally located at the top on the left and containing the headline chosen by the commercial user and/or the descriptive text from the commercial user and/or text describing the content of the digital medium (SN2 & SN1).

EV1-C

The field for the sender's message: Normally located at the foot of the envelope and containing the sender's typewritten and/or handwritten and/or printed message.

EV2—On the back side of the envelope: (6)

Are printed a group of described elements, the number, arrangement and dimensions of which are given here only as a non-restrictive example:

EV2-D

The field for legally required information: Normally located at the foot of the back side of the envelope (6) and containing the artists' and/or manufacturers credits and/or copyrights and/or description of the area of responsibility and/or the legally required details of the commercial user.

EV2-E

The field for the sender's address and/or the logo of the commercial user: Normally located at the top of the back side of the envelope (6) and containing a space reserved for the sender's address and/or a space reserved for the logo of the commercial user.

ST—The translucent pouch: (9&10)

In the distribution context this translucent pouch serves to enclose all the elements of the invention at the same time as serving to display and market the device as a whole to the public. It can contain a self-adhesive (10)

AR, VR, XR, CA: the three connecting devices and a wedging device and the connecting pin (21 & 22 & 23 & 24 & 25):

AR: (21)

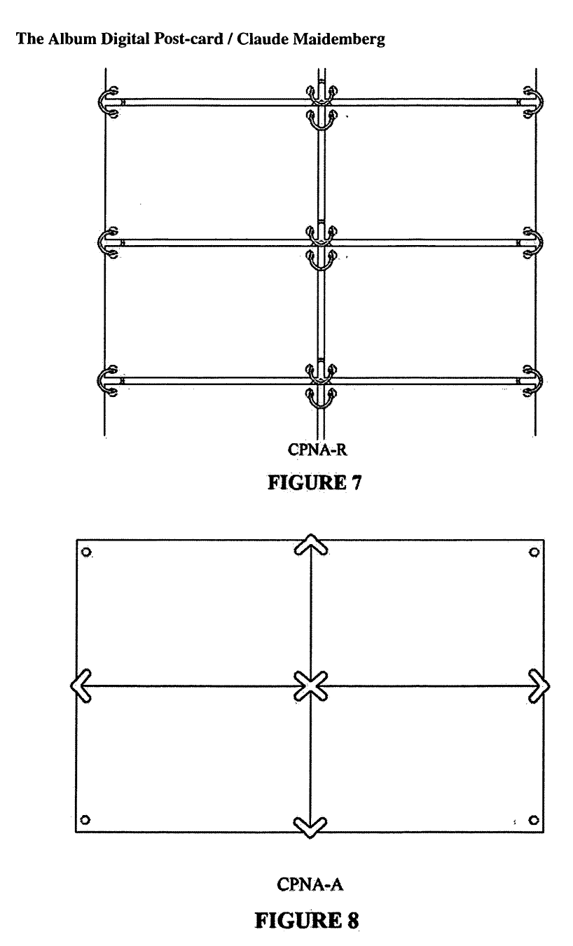

The connecting ring is a connecting device comprising a ring made from metal or from any other material of sufficient resistance equipped with an opening (ARO) for the CPNA to pass through the ring. Then the connecting ring slides through the holes previously hollowed (prepunched holes SM2-K1-2-3-4) to connect the [00056] CPNA cards to each other. Non-restrictive examples of connection were given in FIG. 7.

VR: (22)

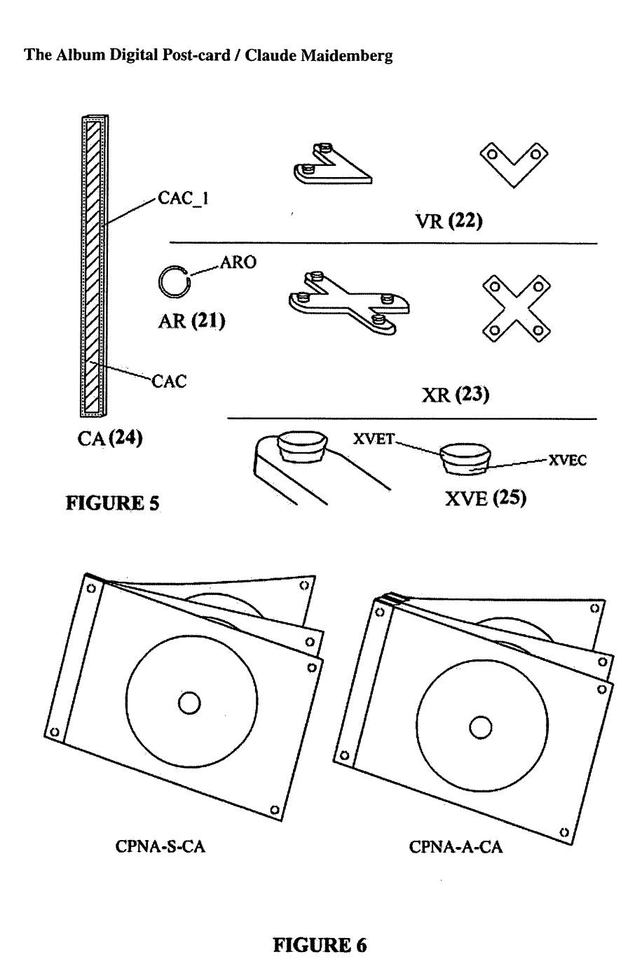

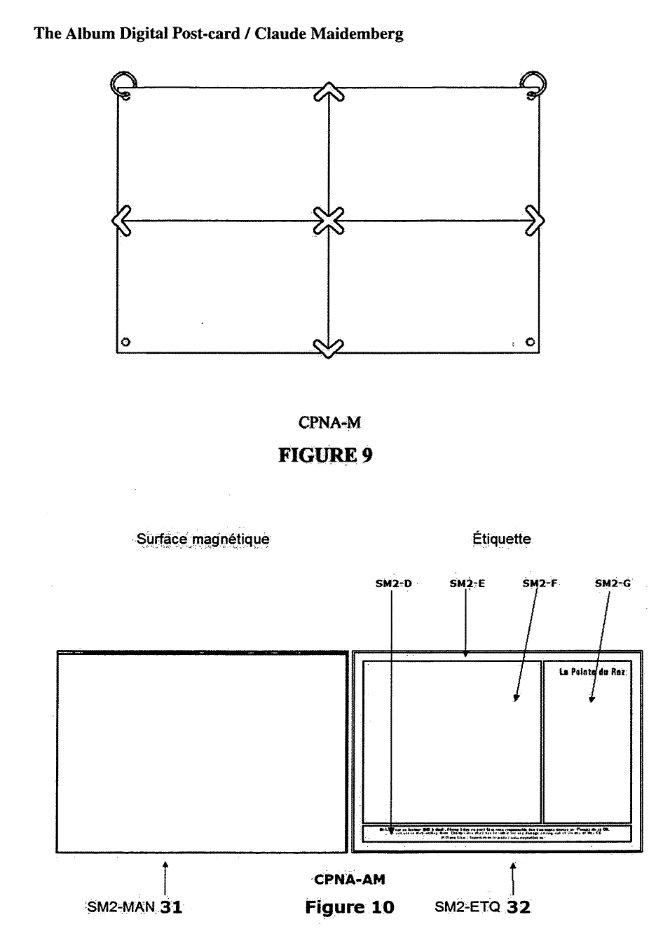

Bi-card connecting device in the form of a “V” connecting two CPNA cards literally without distinction horizontally or vertically. To connect two CPNAs the connecting pin of VR (XVE) must be placed in one of the prepunched holes (SM2-K1-2-3-4) of the first CPNA, then the same operation must be repeated for the second CPNA. To place a connecting pin XVE in a hole SM2-K the head of the connecting pin (XVET) must be presented opposite the hole SM2-K and then the connecting pin XVE must be placed inside the hole of the CPNA by applying slight pressure. The neck of the connecting pin (XVEC) having more or less the same height as the thickness of the CPNA, the two cards connected by a VR will be stabilized by the heads of the connecting pins XVET. Inversely, we can separate two CPNAs connected by a VR. These connecting and separating operations may be repeated a relatively large number of times, FIG. 5. Non-restrictive examples of connection were given in FIGS. 8 and 9.

XR: (23)

Quadri-card connecting device in the form of a “X” connecting four CPNAs by one of their four corners, FIG. 5. To connect four CPNAs with a XR the same process as for the VR must be followed positioning the XR in the centre of the 4 CPNAs. Non-restrictive examples of connection were given in FIGS. 8 and 9.

CA: (24)

The album wedge is a wedging device with a self-adhesive strip (CAC) and its protective film (CAC_1) on one side serving to wedge a relatively large number of CPNAs in such a way as to obtain a voluminous and perfectly symetrical album. By applying the self-adhesive strip of the back side of the CPNA to the ordinary surface of the album wedge, we have the surface with the self-adhesive strip of the album wedge (CAC) to attach the entire unit to the front side of another CPNA and so on, FIG. 5. A non-restrictive example of connection was given in FIG. 6.

VXE: (25)

We note in detail (XVE) two separate parts constituting the connecting pin of the XRs and VRs. The first part is the neck of the connecting pin (XVEC), which has more or less the same diameter as the internal diameter of the prepunched hole of the SM (SM2-K1/2/3/4) and more or less the same height as the diameter of an CPNA. The second part is the neck of the connecting pin (XVET), which has a much greater diameter so as to keep the CPNA in place, FIG. 5.

Assembling:

The CPNA is the result of assembling the 5 elements previously described and their 4 add-ons.

The reusable and repositionable fixing device (7) is attached to the place chosen by the commercial user. The digital medium (3&4) is fixed on the DFR (7) simply by pressure. Then the digital medium (3&4) fixed to the digital medium (1&2) is placed in the envelope (5&6). According to the different methods and configurations of distribution, one or more or all the four add-ons will be added.

In the case of distribution to the general public, the whole assembly is inserted into the translucent pouch (9). In the case of bulk mailing where the personalised message from the commercial user on the material medium (1&2) has to be printed, the Album Digital Post-card is placed under the envelope (5&6) and put in the mail directly by the commercial user without using the translucent pouch (9).

On receipt of the CPNA, the recipient, according to the methods and the configuration expressed in the main characteristic of the CPNA, has the possibility to make a “CPNA Album” (CPNA-S-CA) if the number of CPNAs is relatively low, a “CPNA Album” (CPNA-A-CA) using the album wedges (CA) according to claim 2 if the number of CPNAs is relatively high, or a “CPNA Poster” (CPNA-A & CPNA-M & CPNA-AM) according to claims 3 and 4, or a “CPNA Storage” (CPNA-R) according to claim 5 thanks to the appropriate add-ons.

Putting into circulation:

These are the normal methods of making the invention generally available. Distribution may be, but is not restricted to, dispatch by postal services individually or in bulk mailings, or specialized dispatch and/or distribution, or distribution by hand, or to add to a collection before or after putting into circulation.

Given that the default mode of the invention of digital post-cards of type CPN (Patent No. FR2889823), remedying the major shortcomings in today's electronic communications networks and having the advantages of a traditional paper medium, of an appropriate digital medium and of a suitable means of distribution, and mitigating the defects of each (the limited content of a post-card, the impossibility of personalising their characteristic content and the lack of interactivity personalisable with consumer electronic devices and the Internet) we are distinguished by the addition of the following applications:

By a first characteristic, the possibility of assembling the CPNAs in “CPNA Album” principal implementation mode prior to their distribution by the sender or distributor or following grouped or individual receipt of the CPNAs by the recipient. This method of implementation is broken down into two variants as follows:

Principal (first claim): CPNA Album without “Album Wedge” (CA) to group together a small number of CPNAs in an album (CPNA-S-CA).

Secondary (second claim): CPNA Album with “Album Wedge” (CA) to group together a large number of CPNAs in an album (CPNA-A-CA).

According to the characteristic described by claim 3, the CPNA may be mounted in “CPNA Poster” mode thanks to the appropriate add-ons to enable it to be used as a poster or a “photo frame” on a desk or a piece of furniture or against a surface or a wall like a poster. The “CPNA Poster” may also be used to display CDs, and/or DVDs and/or Blu-Ray DVDs. This method of implementation is broken down into three variants as follows:

CPNA-A: “CPNA Poster” by connecting the CPNAs to each other so that they can be fixed onto a wall medium or onto any surface as a poster.

CPNA-M: “CPNA Hybrid” to enable it to be used as a poster fixed against a surface or a wall or displayed (suspended or hung by a hook) and/or as a curtain or a sign suspended thanks to the appropriate add-ons.

CPNA-AM: “CPNA Magnetic Poster” with a magnetic back side (SM2-MAN) enabling it to be fixed by its magnetic force to any metal surface allowing this. This variant is accompanied by a non-obligatory label (SM2-ETQ) (32) with certain sub-characteristics to enable its sender to send it as a post-card.

According to the characteristic described by claim 5, the CPNA may be mounted prior to or following its distribution in “CPNA Storage” mode thanks to the appropriate add-ons to enable its recipient to make an archiving object or storage object for CDs and/or DVDs and/or Blu-Ray DVDs. The “CPNA Storage” may be fixed against a surface or a wall or be folded to be placed on a piece of furniture (CPNA-R).

The CPNA in this example comprises chiefly a material medium (SM) measuring 10.5 cm×15 cm printed detailed as follows:

SM1-A contains between 1 and 10 photographs of the main subject. These photographs or vignettes are of equal and/or different dimensions, one of them being larger so as to facilitate the iconographic legibility of the SM1-A.

SM1-B_1 contains the name of the main subject.

SM1-B_2 specifies the number of photographs and the viewing time of the content of the digital medium SN (e.g. 12 minutes).

SM1-B_3 represents the logo of the main subject and/or that of the commercial user.

SM1-C is the centre of the MM1-A where the DFR(7) is located. This centre is offset to the right when SM1-B_1 and SM1-B_2 are arranged in a strip on the left of SM1-A. The layout of the SM1-A determines the position of SM1-C.

SM2-D indicates the commercial user's level of responsibility after the CPNA has been circulated to the public as well as the copyright lines and the usual signatures of the designers and manufacturers.

SM2-E is a background of images reproducing a single photograph from among those in SM1-A and of the specific message from the commercial user, in light tones in so as to allow the subsequent overprinting of a personalised message.

SM2-F is the field for the commercial user's message.

SM2-G comprises the name of the main subject and the number of photographs for the viewing time of the content in the digital medium SN and the logo of the main subject, as well as the text describing the content of the digital medium (SN1 and SN2).

The sample CPN comprises secondly a SN measuring 8 cm detailed as follows:

SN1-A reproduces in silk-screen a portion or the whole of the photograph located under the Digital Medium SN when it is placed on the DFR.

SN1-B_1 reproduces a slogan and a promotional hook of the main subject.

SN1-B_2 indicates the number of photographs and/or videos and or Internet links contained in the Digital Medium SN, and the relevant viewing time.

SN1-B_3 reproduces the logo of the commercial user of the main subject.

SN2-A:

The functionality of the type CPN (Patent N° FR2889823) containing the photographs and/or videos contains, according to the new main characteristic, the Internet links and the additional engine of personalisable interactivity of the Blu-Ray DVD players.

SN2-A:

contains the musical soundtracks

contains the natural sounds relating to the photographs and/or videos and/or Internet links

contains the original sound-effects of the photographs and/or videos and/or Internet links

contains the recorded voices reading a text relating to the photographs and/or videos and/or Internet links

is used for crossheadings and fixed and animated text panels

contains opening credits

contains closing credits

comprises legally required information

is used for the personalised montage of photographs and/or videos and/or Internet links

is used for the handling of credits

inserts sequences of still shots and/or videos and/or Internet links

makes use of special visual effects

to present on the screen following the opening credits and an interface. It comprises selectable vignettes from the chapters allowing direct access to the number corresponding to the images and/or videos and/or Internet links

SN2-B:

According to its main characteristic, the CPNA uses applications to link to the Internet from a Blu-Ray DVD player. This characteristic is in addition to the applications of the digital post-cards of the type CPN (Patent N° FR2889823). According to the main characteristic, both types of application can now be used on PC compatible computers and/or Macintosh computers and/or on games consoles and/or on video cameras equipped with a VCD player and/or DVD player and/or in a television environment and with a Blu-Ray DVD player having the possibility to connect to the Internet.

The sample CPNA comprises thirdly an DFR, the reusable and repositionable fixing device (7&8) with a diameter of 15 mm and a height of 18 mm positioned on the zone described in SM1-C.

The sample CPNA comprises fourthly an (EV) measuring 11.5 cm by 16.3 cm detailed as follows:

EV1-A contains the stamp in the case where the sender uses the mail.

EV1-B contains the name and logo of the commercial user of the main subject and a graphic representation of the main subject.

EV1-C contains the address of the recipient of the CPN in the case where the sender uses the mail.

EV2-D contains the artists' and manufacturers' credits and copyrights, and a description of the area of responsibility and legally required details of the commercial user.

EV2-E contains the logo of the commercial user of the main subject and the address of the sender.

The sample CPNA comprises fifthly a ST (translucent pouch) measuring 12 cm by 16.5 cm.

The sample CPNA comprises sixthly a self-adhesive (10) to seal the ST (9).

The assembling of the sample CPNA is described as follows:

The entire Material Medium (SM) and Digital Medium (SN) mounted on the reusable and repositionable fixing device (DFR) is inserted with the envelope (EV) in the translucent (ST) (9) so as to be displayed and marketed to the public.

The putting of the sample CPNA into circulation is described as follows:

Given a digital post-card of the type CPN (Patent N° FR2889823), the CPNA is dispatched by mail to the desired correspondent, where it is kept as a souvenir by its purchaser. The CPNAs can be assembled in three variants:

According to the first characteristic the variant named “CPNA Album”, “CPNA Storage” and “CPNA Poster” before or after their dispatch.

Indication of the Way in which the Invention can have Industrial Applications

Given a digital post-card of the type CPN (Patent N° FR2889823) we distinguish ourselves by the following variants:

VAR01, The Virgin CPNA:

The Virgin CPNA variant is designed for private individuals and professionals to enable them to make photographic prints and/or video montages and/or interactive links to Internet sites, and for owner-operators of public relations companies and departments.

It is made up of virgin, unprocessed elements made available to the public and professionals for the purpose of personalisation and distribution. The CPNA thus comprises the virgin and printable SM and SN1, as well as a virgin SN2 ready for engraving or pressing, a virgin DFR, and a virgin, printable EV and a ST.

VAR02, The Online Interactive Catalogue:

The Online Interactive Catalogue variant is designed for commercial users in the areas of manufacturing and the conception of online (or traditional) products and services, as well as industrial, commercial, distribution, advertising and communication companies, natural domains and natural sites, tourism, museums, monuments and art centres having a commercial (or traditional) site to operator using the interactive personalisable interaction features of CPNA (SN2-B).

The three means of implementation, “CPNA Album”, “CPNA Storage” and “CPNA Poster”, are perfectly applicable to this variant.

VAR03, The Multimedia Archive Book:

The Multimedia Archive Book variant is designed for personal use, operators of public relations companies and departments, for the areas of product manufacture and services, for industrial, commercial and distribution businesses and for advertising agencies, whether traditional or with a professional online site. It consists of a group of CPNAs assembled thanks to the connecting device with a wedge (CA), supplemented or not by a summary detailing the contents of the different CPNAs connected in the Book, and containing a group of films and/or video sequences and/or archived photographs classified according to themes and/or subjects and/or titles and/or authors and/or producers and/or composers and/or artists and/or any other means of reference and/or links to the sites concerned using the interactive personalisable interaction features of the CPNA (SN2-B).

The three means of implementation, “CPNA Album”, “CPNA Storage” and “CPNA Poster”, are perfectly applicable to this variant.

VAR04, Promotion:

La Promotion variant is designed for the operators of public relations companies and departments, for the areas of product manufacture and services, for industrial, commercial and distribution businesses and for advertising agencies, whether traditional or with a professional online site.

It consists of a promotional message presented in the form of an advertising film and/or strip with interactive links to Internet sites in order to convey to a professional recipient and/or the general public the information and the desire to discover and/or acquire certain goods and/or services through the interactive content of CPNA and/or its interactive links to the corresponding sites using the interactive personalisable interaction features of the CPNA (SN2-B).

The three means of implementation, “CPNA Album”, “CPNA Storage” and “CPNA Poster”, are perfectly applicable to this variant.

A function for printing the principal elements such as the promotional offer is actioned when the player used is linked to a printer.

VAR05, The Clip CPNA:

The Clip variant is designed for users in production companies in the entertainment industry, in film-making, live entertainment and music, for record companies, for the operators of television networks and radio stations, for the directors of films and videos, for musicians and for cultural institutions, associations and companies.

It consists of an item of audio-visual content made up of musical compositions and/or artistic performances and/or live shows and/or clips and/or text/poetry reading and/or an audio-video montage which has the same structure as a VCD or DVD or a Blu-Ray DVD.

This variant opens the way to the whole online multimedia communication wealth of the CPNA. The variant provides the opportunity to synthesise the content of an original CD/DVD/Blu-Ray DVD and/or one created for the occasion by the above-mentioned commercial users, as well as the possibilities of personalisable interaction connected to the specific applications of the CPNA. It also the possibility for personalising the content of the CPNA by the final users who, for each “unique” personal creation, make use of the functions described in (SN2-A/B).

The three means of implementation, “CPNA Album”, “CPNA Storage” and “CPNA Poster”, are perfectly applicable to this variant.

VAR06, Audio CPNA:

The Audio CPNA variant is designed for the same commercial users as the VAR05, CPNA Clip. It consists simply of an item of audio content only. The Audio CPNA variant benefits from the same possibilities of connected interaction and personalisation (SN2-A/B) for the same public as the VAR05, CPNA Clip variant.

The three means of implementation, “CPNA Album”, “CPNA Storage” and “CPNA Poster”, are perfectly applicable to this variant.

VAR07, Reporting and Magazine:

The Reporting and Magazine variant is designed for individuals, for commercial users in the areas of manufacturing and the conception of online (or traditional) products and services, as well as industrial, commercial, distribution, advertising and communication companies, natural domains and natural sites, tourism, museums, monuments and art centres, and for newspapers and television journalism and for companies producing audiovisual works having an Internet site (or traditional) to operator.

The aim of the reporting and/or magazine is to present and/or explain a subject concerning a business and/or an institution and/or event organizing. It consists of a film in sequences each covering an aspect of the subject. To present the subject, the film uses video and/or photographs and/or text and/or a soundtrack made up of pieces of music and/or sound-effects and/or live commentaries. It contains opening and closing credits (SN2-A). It also has interactive links with the sites concerned to supplement or update the content of CPNA in real time (to the extent possible) (SN2-B).

The three means of implementation, “CPNA Album”, “CPNA Storage” and “CPNA Poster”, are perfectly applicable to this variant.

VAR08, The Animation Application:

The Animation Film variant is designed for the above-mentioned operators and, in particular, for producers of works for children.

It consists of one or more animation sequences based on non-animated images, logo and text, intended to present a fictional subject and/or to illustrate a real-life subject, be it sociological and/or commercial and/or industrial, with the interactive links using the interactive personalisable interaction features of the CPNA (SN2-B).

The three means of implementation, “CPNA Album”, “CPNA Storage” and “CPNA Poster”, are perfectly applicable to this variant.

VAR09, The Invitation Card:

The Invitation Card variant is designed for the above-mentioned operators and, in particular, for personal use.

It involves the connected and interactive (SN2-B) deployment of all the usual elements of an invitation: date, place, heading, explanations and comments, with the addition of sound and images and/or videos and/or animation presented in the form of multimedia application (SN2-A).

The three means of implementation, “CPNA Album”, “CPNA Storage” and “CPNA Poster”, are perfectly applicable to this variant.

VAR10, The Personal Announcement:

The Personal Announcement variant is a special version of the Invitation Card variant, and is specifically designed for personal use.

It involves the connected and interactive deployment of all the usual elements of a personal announcement: date, place, title of the event, explanations and comments, with the addition of sound and images and/or videos and/or animation presented in the form of multimedia application (SN2-B).

A function for printing the principal elements such as a personal announcement on paper is available when the player used is linked to a printer (SN2-A).

The three means of implementation, “CPNA Album”, “CPNA Storage” and “CPNA Poster”, are perfectly applicable to this variant.

VAR11, The Selection of Works:

The Selection of Works variant is a special version of the Interactive Catalogue variant and is designed specifically for art galleries, for artists and craftsmen and for private collectors.

It consists of an electronic exhibition catalogue, connected to the corresponding sites, presenting art works in a video form, whether they are animated and/or plastic and/or in the form of photographs or other 2-dimensional works. A classification appears in the form of (SN2-A/B). A function for printing the principal elements such as a catalogue on paper is available when the player used is linked to a printer.

The three means of implementation, “CPNA Album”, “CPNA Storage” and “CPNA Poster”, are perfectly applicable to this variant.

VAR12, The Artist's Portfolio:

The Artist's Portfolio variant is a special version of the Interactive Catalogue variant and is designed specifically for artists and models, for public professions and for businesses and institutions which support a creative artist.

It consists of an interactive multimedia curriculum vitae connected to the corresponding site, made up from photographs, videos, text and a soundtrack containing a spoken commentary and observations, as well as sound-effects, music and videos. This content is structured in such as way as to allow smooth navigation from one piece of information to another (SN2-A/B). A function for printing the principal elements such as the illustrated curriculum vitae is available when a player used is linked to a printer.

The three means of implementation, “CPNA Album”, “CPNA Storage” and “CPNA Poster”, are perfectly applicable to this variant.

VAR13, The Individual Portrait:

The Individual Portrait variant is a special version of the Promotion variant and is designed specifically for artists and models, for private individuals and public professions, for publishers and for businesses and institutions which support an individual and publishers. It consists of an interactive multimedia portrait made up from photographs, scans of documents, videos, text and a soundtrack containing a spoken commentary and observations, as well as sound-effects, music and videos. This content is structured in such as way as to allow smooth navigation from one piece of information to another. (DM2-A/B). A function for printing the principal elements such as the summary of the illustrated portrait is available when the player used is linked to a printer.

The three means of implementation, “CPNA Album”, “CPNA Storage” and “CPNA Poster”, are perfectly applicable to this variant.

VAR14, The Business Card:

The Business Card variant is a special version of the Individual Portrait variant and is designed specifically for owners and operators of public relations companies and departments, for all businesses and associations, and for personal use.

It comprises a material medium (SM) and a digital medium (SN) in a format corresponding to the formats of traditional business cards. The form of the (SN) is designed in such a way that the SN does not physically extend beyond the edges of the SM. For this purpose the necessary cutouts are applied to the SN by the manufacturer. The Business Card variant contains all the elements of information about a company or an institution or an individual person in the form of photographs, videos, text and sound assembled and organised in sequences that can be consulted through a graphic environment adapted to navigation to the content of the CPNA (SN2-A) and to the sites that are accessible thanks to the connected personalisable interactivity features (SN2-B). A function for printing the principal elements such as configurable visible card is available when the player used is linked to a printer. The two means of implementation, “CPNA Storage” and “CPNA Poster”, are perfectly applicable to this variant.

VAR15, The Souvenir:

The Souvenir is a special version of the Promotion variant and is designed specifically for owners and operators in the fields of museums, monuments, leisure locations, visitor attractions, galleries, artists, private and public collectors, for institutions, for traditional publishers and for publishers of derived products, and for consultancy firms producing this variant as a souvenir or collectible object.

The material medium (SM) and the physical appearance of the digital medium (SN) of this variant comprise the characteristics of a collectible object. The content in the form of still or animated images, with/without soundtrack, archives or current news and/or events and their interactive links can confirm this aspect.

The three means of implementation, “CPNA Album”, “CPNA Storage” and “CPNA Poster”, are perfectly applicable to this variant.

I claim:

1- Given the digital post-cards of the type Digital Post-card CPN comprising a material medium, a digital medium and a repositionable fixing device reusable at will adhering due to the self-adhesive part onto the material medium to keep the digital medium on its central core, and an envelope and a translucent pouch, the whole comprising traditional content and digital multimedia content, a device concerning this invention, the Album Digital Post-card CPNA, characterised by the fact that the CPNA comprises a material medium (SM) having a front side (SM1) and a back side (SM2), and one or two self-adhesive strip(s) (SM2-H, SM2-J) with or without a fluting field (SM2-I) and a digital medium (SN) having a front side(SN1) and a back side (SN2), and a repositionable fixing device (DFR) (7&8) reusable at will adhering due to the self-adhesive part (7) to the material medium (SM) (1&2) to keep the digital medium (SN) (3&4) on its central hole (8), and an envelope (EV) (5&6) and a translucent pouch (ST) (9), the whole comprising traditional (by printing) and digital (by digital memory medium) multimedia content, being able to be mass-produced, and the connected interaction functions of SN being personalisable in parallel (SN2-B), due to the self-adhesive strips SM2-H or SM2-J, the CPNAs can be grouped together and attached to each other to create the “CPNA Album”, the principal implementation of the invention (CPNA-S-CA).Given the digital post-cards of the type Digital Post-card CPN comprising a material medium, a digital medium and a repositionable fixing device reusable at will adhering thanks to the self-adhesive part onto the material medium to keep the digital medium on its central core, and an envelope and a translucent pouch, the whole comprising traditional content and digital multimedia content, a device concerning this invention, the Album Digital Post-card CPNA, characterised by the fact that the CPNA comprises a material medium (SM) having a front side (SM1) and a back side (SM2), and one or two self-adhesive strip(s) (SM2-H, SM2-J) with or without a fluting field (SM2-I) and a digital medium (SN) having a front side (SN1) and a back side (SN2), and a repositionable fixing device (DFR) (7&8) reusable at will adhering thanks to the self-adhesive part (7) to the material medium (SM) (1&2) to keep the digital medium (SN) (3&4) on its central hole (8), and an envelope (EV) (5&6) and a translucent pouch (ST) (9), the whole comprising traditional (by printing) and digital (by replaceable memory) multimedia content, being able to be mass-produced, and the connected interaction functions of SN being personalisable in parallel (SN2-B). The CPNAs can be grouped together and attached to each other thanks to the self-adhesive strips SM2-H or SM2-J to create the “CPNA Album”, the principal implementation of the invention (CPNA-S-CA).

2- Device described in claim 1 characterised by the fact that, by using an album wedge (CA)(24) to be inserted between a relatively large number of CPNAs, results in an album that is voluminous and perfectly symmetric, the “CPNA Album with wedge” (CPNA-A-CA).

3- Device described in claim 1 characterised by the fact that the material medium SM can comprise four prepunched holes (SM2-K1-2-3-4) acting to connect the cards together for the purpose of exhibition and/or display and viewing by using connecting add-ons (AR, VR et XR) (21, 22 et 23) a set of CPNAs can be used as a poster “CPNA Poster” (CPNA-A) being secured by the self-adhesive strips (SM2-H-J) to a wall medium or any surface and/or being displayed (suspended or hung by a hook), and due to the appropriate add-ons, the device can also be used as a curtain or a sign (suspended or hung by a hook) “CPNA Hybrid” (CPNA-M).

4- Device described in claims 1 and 3 characterised by the fact that the material medium SM can have a magnetic back side (SM2-MAN) (31) enabling it to be fixed by its magnetic force to any metal surface enables its sender to send it as a post-card “CPNA Magnetic Poster” (CPNA-AM) therefore this variant is accompanied by a non-obligatory label (SM2-ETQ) (32).

5- Device described in claims 1 and 3 characterised by the fact that the material medium SM can be used as a means for storing and/or mural archiving of CDs/DVDs/Blu-Ray DVDs or as an independent storage device for placing on a desk or on any piece of furniture “CPNA Storage” (CPNA-R).
